(19) United States
(12) Patent Application Publication
(10) Pub. No.: US 2019/0000267 A1
(43) Pub. Date: Jan. 3, 2019

(54) COMBINATION ELECTRIC TOASTER OVEN AND AIRFRYER

(71) Applicants: George T.C. Li, Reno, NV (US); Eric Li, Martinsville, VA (US)

(72) Inventors: George T.C. Li, Reno, NV (US); Eric Li, Martinsville, VA (US)

(21) Appl. No.: 15/640,368

(22) Filed: Jun. 30, 2017

(51) Int. Cl. A47J 37/06; A47J 37/08

(52) U.S. Cl. CPC A47J 37/0641; A47J 37/047; A47J 37/08

(57) ABSTRACT

A combination toaster oven and air fryer is described. The combination toaster oven and air fryer includes a housing, a door, a fan, basket drive element, a basket, a first heating element, a second heating element, and a control panel. The combination toaster oven and air fryer provides toasting, baking, and air frying cooking modes in a single stand-alone countertop unit. The first heating element includes a tubular infrared heater and a tubular quartz heater positioned to avoid crumbs falling from the basket during rotation and optimally cook and crisp food product.

### FIELD

The present disclosure relates to a combination electric toaster oven and air fryer. More particularly, the present disclosure relates to a combination electric toaster oven and air fryer that includes a heating element disposed adjacent to a removable rotating basket.

### BACKGROUND

A variety of stand-alone toaster ovens have been developed to cook and toast different food products (e.g., pizza, toast, sandwiches, chicken nuggets, instant foods, and the like) without the use of a conventional kitchen oven. Separately, a variety of stand-alone air fryers have been developed to cook/fry different food products (e.g., French fries, chicken nuggets, chickens, vegetables, etc.) without the use of a conventional kitchen oven or deep fryer.

Toaster ovens and air fryers offer a variety of conveniences including being energy-efficient alternatives to turning on a full-size oven. Toaster ovens and air fryers also provide extra cooking space during the holidays and other events. Air fryers substantially shorten cooking times by constantly replacing the air facilitating convection heating in the cooking chamber or basket, thereby increasing the rate of energy transfer from the heating element to the food product. Toaster ovens provide additional utility, such as baking and broiling. Generally, toaster ovens also include a removable rack to easily transport food product to a serving dish, while air fryers include removable baskets or basins that similarly facilitate transportation of food product to a serving dish or platter.

Typical toaster ovens include electric resistive heating rods for applying heat to the bottom and top of food product. These heating rods are typically dispersed throughout an interior cooking chamber of the toaster oven to provide approximately uniform heating to all regions of the cooking chamber. The food product typically rests upon a removable rack or tray, which in turn rest upon rails mounted on the interior of the cooking chamber. Such racks and trays are often constructed of aluminum, stainless steel or enameled steel for reasons of durability and sanitation.

Typical air fryers include a heating source positioned to heat food product in a removable basket or basin housed within a cooking chamber of the air fryer. This heating is facilitated and enhanced by circulating heated air through the cooking chamber to continuously replace air that has cooled on contact with the food product. Like the racks and trays used in toasting ovens, the basins and baskets are often constructed of aluminum, stainless steel or enameled steel for reasons of durability and sanitation.

Existing toaster ovens and air fryers share several components and purposes, but each provides additional utility making it desirable for a home kitchen to have both a toasting oven and an air fryer. However, it is disadvantageous for a home kitchen to contain superfluous cooking implements taking up precious storage and countertop space.

Thus, it would be advantageous to have a toasting oven that included air fryer functionality to limit the space used by the cooking appliance and increase the utility of that cooking appliance.

### SUMMARY

A combination toasting oven and air fryer is described. The combination toasting oven and air fryer includes a housing, a door coupled to the housing, a fan within the housing, a basket drive element, a basket including a drive shaft, a first heating element located below the basket, a second heating element within the housing, and a control panel. The basket has a first state and a second state. In the first state, the basket is coupled to the basket drive element. In the second state, the basket is separate from the basket drive element. The first heating element including an infrared heater and a quartz heater.

In another embodiment, a combination toasting oven and air fryer is described, which includes a housing, a door coupled to the housing, a fan within the housing, a basket drive element, a basket including a drive shaft, a first heating element located below the basket, a second heating element within the housing, and a control panel. The basket has a first state and a second state. In the first state, the basket is coupled to the basket drive element. In the second state, the basket is separate from the basket drive element. The first heating element including an infrared heater and a quartz heater. The control panel includes an air fryer cooking selection and a toaster cooking selection.

### FIGURES

The present invention will be more fully understood by reference to the following drawings which are presented for illustrative, not limiting, purposes.

FIG. 1 shows a perspective view of a combination toaster oven and air fryer as disclosed herein and in accordance with various illustrative embodiments.

FIG. 2 shows a right-side perspective view of the combination toaster oven and air fryer, wherein the basket is removed, as disclosed herein and in accordance with various illustrative embodiments.

FIG. 3 shows a left-side perspective view of the combination toaster oven and air fryer, wherein the basket is removed, as disclosed herein and in accordance with various illustrative embodiments.

FIG. 4 shows a right-side perspective view of the combination toaster oven and air fryer, wherein the basket is installed, as disclosed herein and in accordance with various illustrative embodiments.

FIG. 5 shows a left-side perspective view of the combination toaster oven and air fryer, wherein the basket is installed in the combination toaster oven and air fryer, as disclosed herein and in accordance with various illustrative embodiments.

FIG. 6A shows a detailed perspective view of the basket, as disclosed herein and in accordance with various illustrative embodiments.

FIG. 6B shows an enlarged detailed view of the drive shaft, as disclosed herein and in accordance with various illustrative embodiments.

FIG. 7 shows a cross-sectional front view of the combination toaster oven and air fryer, as disclosed herein and in accordance with various illustrative embodiments.

FIG. 8 shows an exploded view of the first heating element, as disclosed herein and in accordance with various illustrative embodiments.

FIG. 9 shows a cutaway right-side perspective view of the combination toaster oven and air fryer, as disclosed herein and in accordance with various illustrative embodiments.

FIG. 10 shows a cross-sectional right-side view of the combination toaster oven and air fryer, as disclosed herein and in accordance with various illustrative embodiments.

FIG. 11 shows a view of the basket and basket removal tool, as disclosed herein and in accordance with various illustrative embodiments.

FIG. 12 shows a partial cutaway right-side perspective view of a fan of the combination toaster oven and air fryer, as disclosed herein and in accordance with various illustrative embodiments.

FIG. 13 shows a circuit diagram of the combination toaster oven and air fryer, as disclosed herein and in accordance with various illustrative embodiments.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the apparatus, systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

The designations “right” and “left” as used herein when describing the illustrative embodiments disclosed in the drawings are included for clarity only. In various embodiments, the components of the illustrative toaster oven and air fryer 100 may be mirror images of the illustrative embodiments described herein, i.e. all right-side components may also be left-side components and all left-side components may be right-side components in other embodiments.

The combination toaster oven and air fryer disclosed herein overcomes the deficiencies of existing toaster ovens and air fryers by integrating the functionality of a toaster oven and an air fryer into a single stand-alone countertop unit. Existing air fryers include a cooking container, such as a basket or bowl, but lack the capability of accepting an alternative cooking surface, such as a tray or rack. Further, existing air fryers lack the capability to toast or bake food products, and therefore are unable to cook food products, such as bread, pizza, and cookies. In contrast, existing toaster ovens may include a basket or rack, but more often utilize a tray. Existing toaster ovens frequently utilize trays because crumbs, grease, and other food morsels fall through the spaces or holes in racks and baskets onto the heating elements below. Further, the heating elements of existing toaster ovens are arrayed evenly along the bottom and top of the cooking chamber to provide even radiant heat throughout. Thus, the industry standard for toaster ovens is to predominantly utilize a tray to shield the arrayed heating elements from various food morsels and only occasionally employ a rack or basket to limit the mess, fire hazard, and toaster oven wear-and-tear.

The illustrative combination toaster oven and air fryer disclosed herein solves the problems presented by existing toaster ovens and air fryers by providing the functionality of both a toaster oven and an air fryer in a single countertop unit, thereby saving precious countertop, cooking, and storage space. The combination toaster oven and air fryer includes an alternative heating element to the standard array of resistive rods commonly employed in toaster ovens that enables rotisserie style cooking in a basket without concerns of crumbs falling onto an active heating element. This heating element is located such that crumbs falling from the rotating basket do not contact this active heating element. The further inclusion of a fan in the presently disclosed combination toaster oven and air fryer facilitates cooking in a convection or air fryer mode, allowing a user to select among toasting, baking, and air frying cooking options within a single combination toaster oven and air fryer unit.

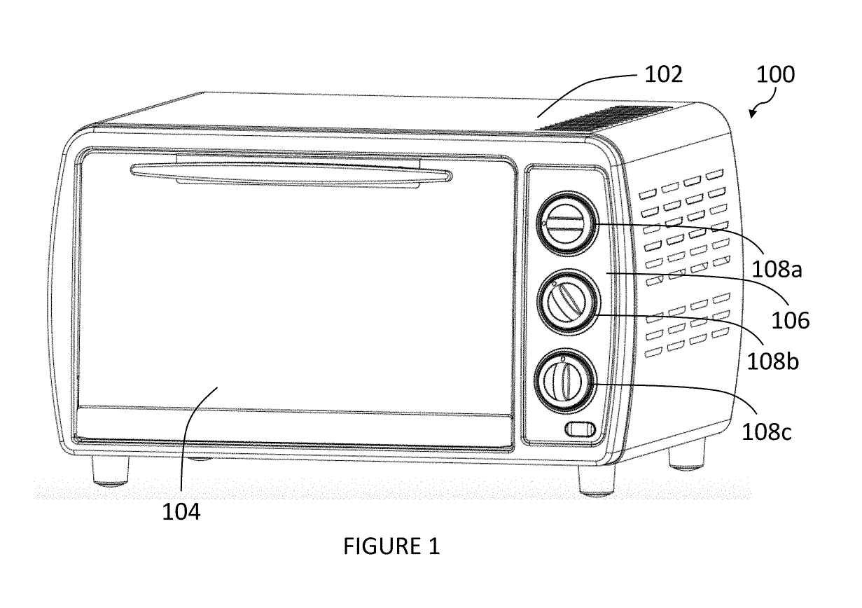

With reference to FIG. 1, there is shown an illustrative combination toaster oven and air fryer 100. The term “toaster oven” can be used interchangeably with “toasting oven,” and the terms are used interchangeably herein. As described herein, the combination toaster oven and air fryer 100 may cook food product on a tray, rack, or basket by toasting, baking, or convection.

The combination toaster oven and air fryer 100 may therefore include a housing 102, a door 104, and a control panel 106. The control panel 106 has a variety of selectors including a temperature selector 108a, a function selector 108b, and a timer 108c.

In various embodiments, the temperature selector 108a may allow a user to select among a plurality of cooking temperatures. In one embodiment, the plurality of temperatures may range from 100 degrees Fahrenheit up to and including 500 degrees Fahrenheit. In another embodiment, the plurality of temperatures may range from 200 degrees Fahrenheit up to and including 450 degrees Fahrenheit. The temperature selector 108a may further include a thermostat (not shown) that regulates the cooking temperature. The function selector 108b may allow a user to select from several cooking modes or functions including Broil, Rotisserie, Toast, Bake, and Air Fryer.

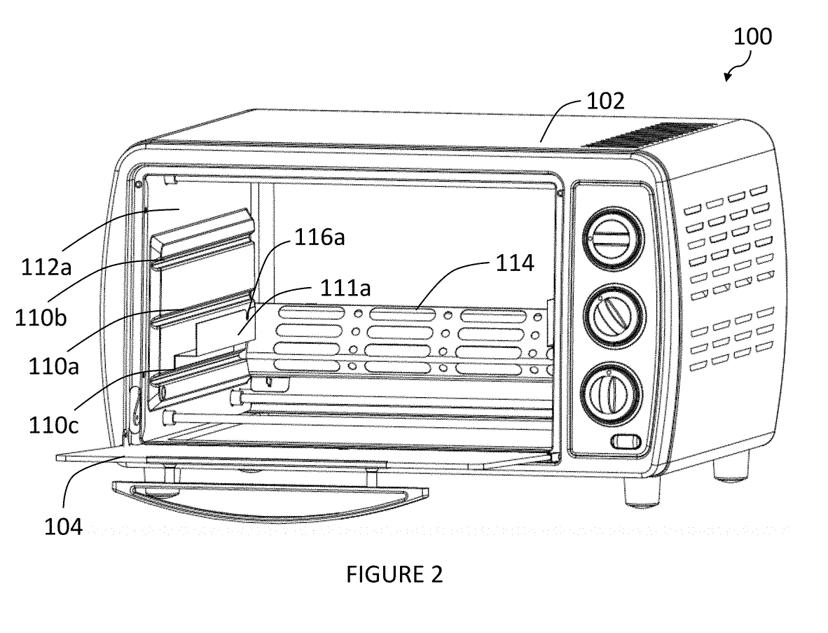

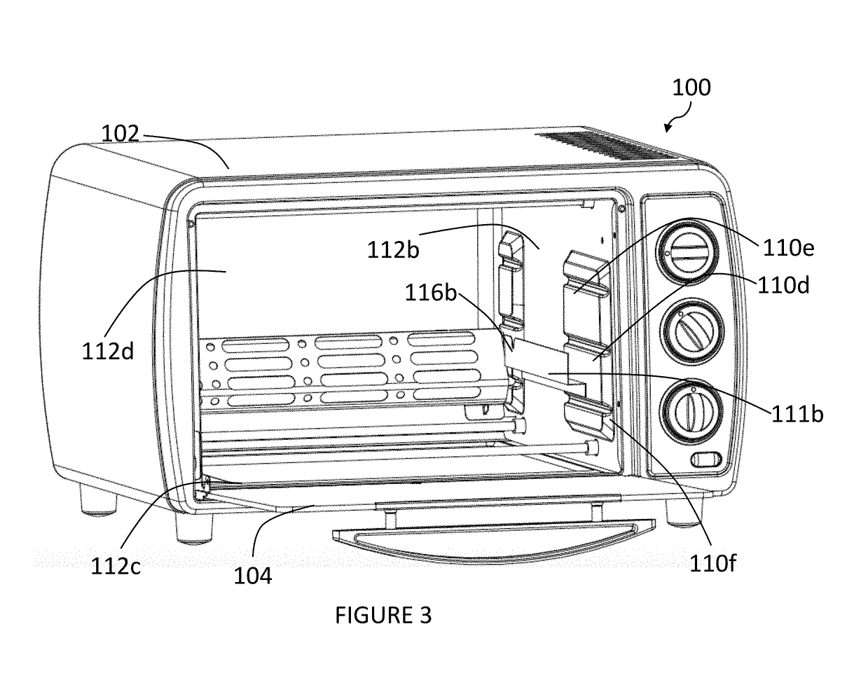

Referring now to FIG. 2, there is shown an illustrative combination toaster oven and air fryer 100 with the door 104 opening on a cooking chamber. The illustrative combination toaster oven and air fryer further including channels 110a, 110b, and 110c disposed on an interior left-sidewall 112a of the housing 102, a guide rail 111a disposed on the interior left-sidewall 112a, and a first heating element 114. Guide rail 111a further includes a notch 116a configured to receive a shaft of a cooking basket described in detail below. With reference now to FIG. 3, the illustrative combination toaster oven and air fryer includes channels 110d, 110e, and 110f disposed on an interior right-sidewall 112b of the housing 102 and a guide rail 111b disposed on the interior right-sidewall 112b. Guide rail 111b further includes a notch 116b configured to receive a shaft of the cooking basket. The cooking chamber is the space within the combination toaster oven and air fryer 100 defined by the door 104, the left-sidewall 112a, the right-sidewall 112b, a bottom wall 112c, a rear wall 112d, and a top wall (not shown). The guide rails 111a and 111b are disposed on the side walls 112a and 112b such that the guide rails 111a and 111b do not interfere with channels 110a and 110d. In one embodiment, the guide rails 111a and 111b are mounted slightly below the channels 110a and 110d and therefore allows channels 110a and 110d to receive a tray or rack during normal toaster oven operation.

In a further embodiment, the guide rails 111a and 111b may comprise flanges that are attached to the side walls 112a and 112b extending away from the side walls and into the cooking chamber. The flanges or guide rails 111a and 111b provide a guide for the horizontal position of the basket 120 and drive shaft 122 when a user installs the basket in the cooking chamber.

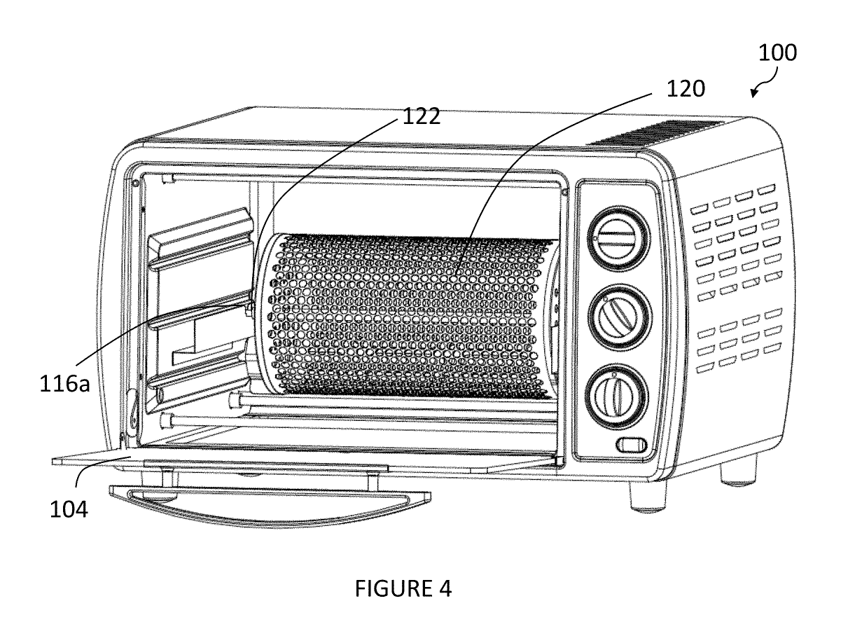

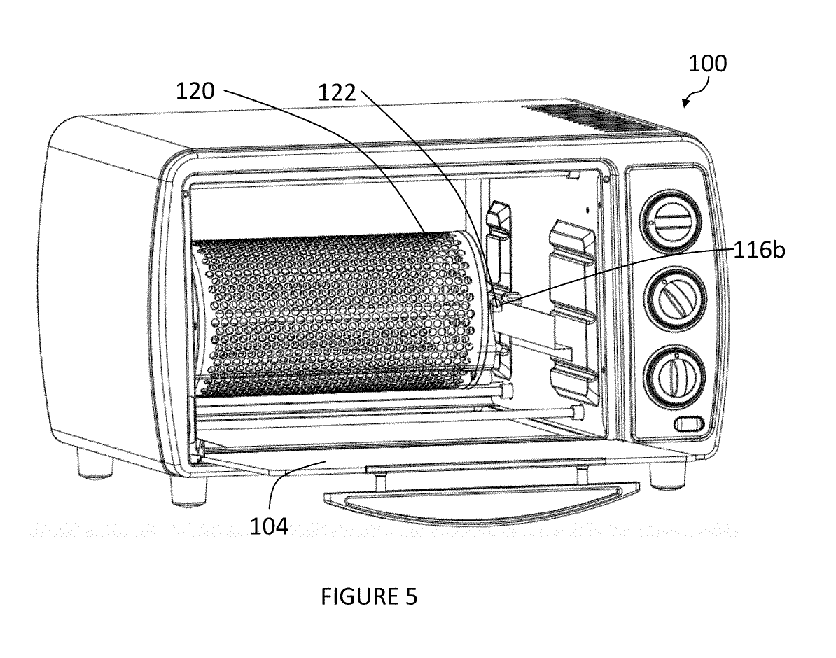

Referring now to FIG. 4, there is shown an illustrative combination toaster oven and air fryer 100 with the door 104 open and a basket 120 in a first state installed within the cooking chamber. A basket drive shaft 122 rests within the notch 116a. With reference now to FIG. 5, the drive shaft 122 of the basket 120 rests within the notch 116b. The basket 120 may rotate about the axis of the drive shaft 122 when installed upon the notches 116a and 116b.

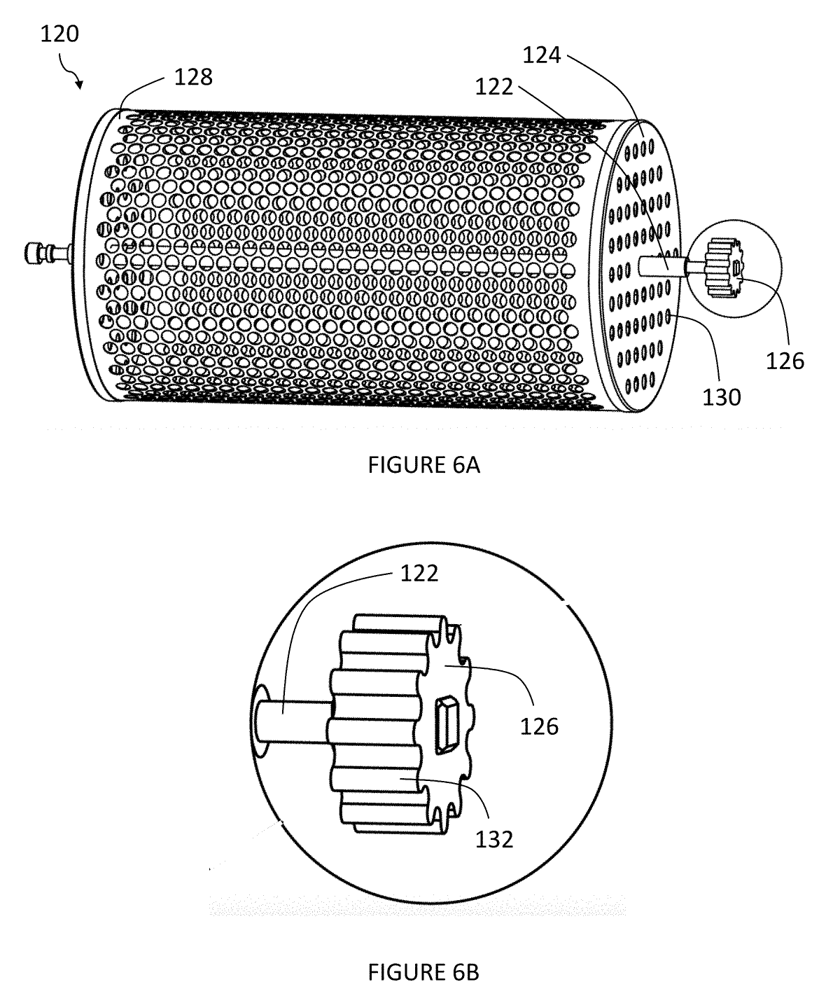

Referring now to FIG. 6A, there is shown the basket 120 in a second state removed from the combination toaster oven and air fryer 100. In the illustrative embodiment, the basket includes a drive shaft 122 that extends through the interior of the basket 122 and through both a right-side surface 124 and a left-side surface (not shown) of the basket 120. In other embodiments, the drive shaft 122 does not extend through the interior of the basket 120, but instead only extends from the left-side surface (not shown) and the right-side surface 124. The basket 120 further includes a drive gear 126 disposed at an end of the drive shaft 122 and an outer surface 128. In the illustrative embodiment, the left-side surface, right-side surface 124, and outer surface 128 include a plurality of holes 130. The holes 130 have a diameter of 6 millimeters and the distance between the center of individual adjacent holes 130 is 8.55 millimeters, leaving 2.55 millimeters of solid surface between individual adjacent holes 130. The basket 120 may be formed from any suitable material, such as steel, stainless steel, enameled steel, and aluminum. Additionally, the various components of the basket 120 may not be formed from the same material or materials, e.g., the drive shaft 122 may be formed of steel while the left-side surface (not shown), right-side surface 124, and outer surface 128 may be formed from aluminum, stainless steel, enameled steel, or some other suitably strong and durable material.

In various embodiments, the left-side surface (not shown), right-side surface 124, and outer surface 128 may be a solid sheet, a wire mesh, or a sheet including a plurality of holes or gaps 130. Wherein the left-side surface (not shown), right-side surface 124, and outer surface 128 are wire meshes, the wire may be selected from among a variety of thicknesses ranging from 1 centimeter to 1 millimeter. Further, the wire meshes may be formed from wire stock that is not simple circular cross-section, but is instead oval or rectangular. Wherein the left-side surface (not shown), right-side surface 124, and outer surface 128 are sheets including a plurality of holes or gaps 130, the holes may be any of a variety of shapes including circular, oval, square, rectangular, rhomboid, quadrilateral, or other higher order symmetric and asymmetric geometric shapes. The holes or gaps 130 may range in size from 1 millimeter up to and including 2 centimeters. Further, the spacing between each of the holes 130 and any adjacent holes 130 may provide for 1 millimeter up to 5 centimeters of solid sheet surface between holes 130. In some embodiments, the left-side surface (not shown) may include a door (not shown) and a locking mechanism (not shown). In other embodiments, the right-side surface 124 may include a door (not shown) and a locking mechanism (not shown). In still other embodiments, the outer surface may include a door (not shown) and a locking mechanism (not shown). The locking mechanism may be a press lock.

In one embodiment, the holes 130 are circular and each have a 6 millimeter hole diameter centered about the hole center. In this embodiment, the holes 130 are spaced such that the center of each hole 130 is separated from the center of any adjacent hole by 8.5 millimeters. This hole size allows for effective and efficient heating and cooking of a food product within the basket 120, while securing the food product within the basket and allowing crumbs to exiting the basket during cooking, which eases later cleaning of the interior of the basket 120.

Referring now to FIG. 6B, there is shown the drive gear 126 mounted on the drive shaft 122. The drive gear 126 has a plurality of teeth 132 that engage with a drive element, described in more detail below, to rotate the basket 120.

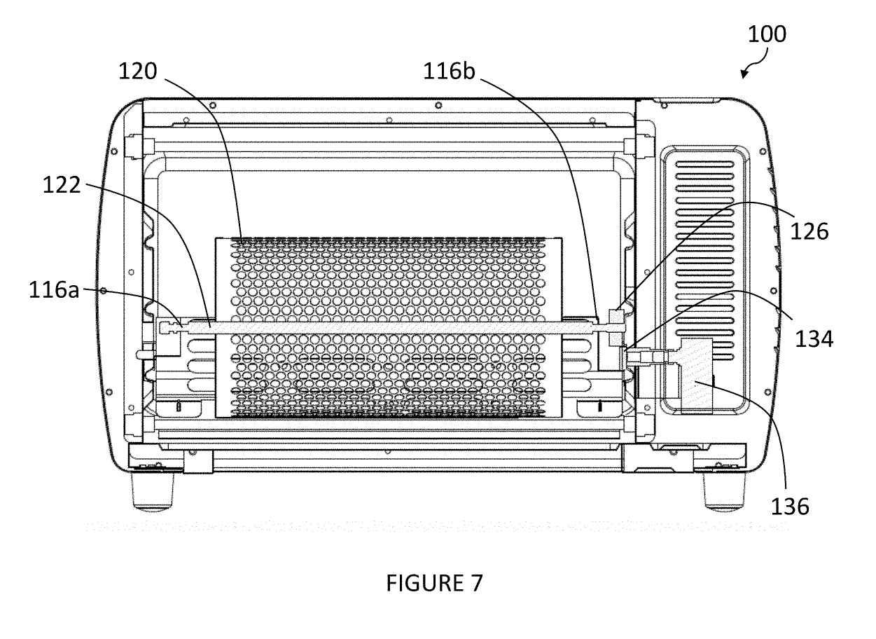

Referring now to FIG. 7, there is shown a cutaway view of the combination toaster oven and air fryer 100 from the front. The drive shaft 122 rests in notch 116a, runs through the interior of the basket 120 to rest in notch 116b. The teeth (not shown) of the drive gear 126 engage with corresponding teeth 134 of the drive element 136 and thereby allow the drive element 136 to rotate the basket 120. The drive element 136 may be an electric motor and output shaft having teeth 134. In various embodiments, the drive shaft 122 does not directly engage with the drive element 136, but instead is rotated by the drive element 136 through a belt drive coupled to the drive shaft 122 and the drive element 136. The guide rails 111a and 111b guide the basket drive shaft 122 and allow the basket drive shaft 122 to slide easily through the cooking chamber, such that the basket drive shaft 122 drops into the notches 116a and 116b. The guide rails 111a and 111b work in combination with the notches 116a and 116b to orient the drive gear 126 such that the plurality of 132 engage the teeth 134 of the drive element 136. Thereby allowing the basket 120 to rotate during operation of the combination toaster oven and air fryer 100.

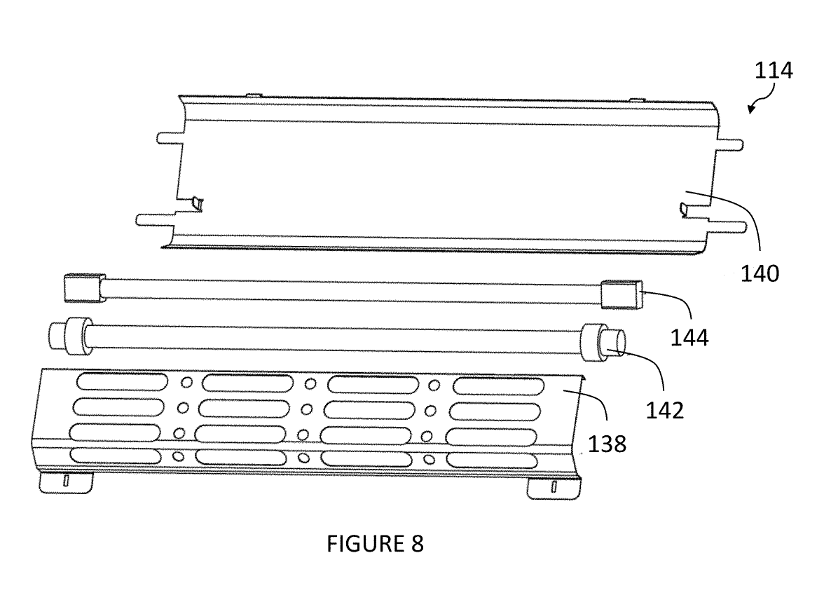

Referring now to FIG. 8, there is shown an illustrative embodiment of the first heating element 114, which comprises a front guard 138, a rear guard 140, a quartz tubular heater 142, and an infrared tubular heater 144. In various embodiments, the first heating element 114 may comprise any one or more of a variety of infrared heaters including quartz heat lamps and tubular heaters. The first heating element 114 may include an infrared tubular heater comprising a quartz glass tube housing any one of a variety of heating elements, such as tungsten, carbon, and alloys having differing amounts of iron, chromium, and aluminum. Further, the first heating element 114 may include any one of a variety of housings suitable for transmitting infrared radiation, such as quartz and ceramics. The first heating element 114 may further include a quartz tubular heater comprising a quartz tube housing a vacuum, air, or other atmosphere.

In one embodiment, the quartz tubular heater 142 comprises a quartz tube housing a resistive filament. The quartz tubular heater 142 emits IR radiation by forcing electricity through the resistive element, which emits black body radiation ranging from visible to far IR, centered about the mid IR range. The quartz tube housing the resistive element absorbs almost all non-IR radiation and re-emits this as IR radiation, far IR radiation, or any combination thereof. The infrared tubular heater 144 comprises a quartz tube that houses a carbon filament sealed in an inert gas environment. The IR tubular heater 144 emits far IR radiation with a similar, but not the same, profile as the quartz tubular heater 142, but at a lower intensity. In this embodiment, the quartz tubular heater 142 heats the food skin or outer layer faster to lead to a crisp skin, e.g. crisp French fries. The IR tubular heater penetrates the food surface to heat the inside of the food more effectively. This combination of heaters results in, for example, French fries with a crisp skin and a soft, moist interior with a faster cooking time than conventional methods and systems.

In various embodiments, the front guard 138 may be fabricated from sheet metal, such as aluminum, steel, and stainless steel; the front guard 138 may also be fabricated from enameled steel or a suitable infrared transparent material such as silicon. The front guard 138 may be a substantially solid sheet lacking holes or including a variety of holes to allow transmittance of heat to the food product in the basket 120 by radiation and convection. The holes may be uniform or variegated and of a variety of sizes ranging from one millimeter to 5 centimeters. The front guard 138 protects the first heating element 114 from damage that may be caused from food objects falling from the basket 120, from handling of the basket 120 by a user during installation of the basket in the combination toaster oven and air fryer 100. Additionally, the front guard 138 shields the first heating element 114 from drippings and other small falling food objects that may coat the first heating element 114 and cause the first heating element 114 to operate inefficiently or cease to operate properly. The rear guard 140 may be fabricated from sheet metal, such as aluminum, steel, and stainless steel; the rear guard 140 may also be fabricated from enameled steel or a suitable infrared transparent material such as silicon. The rear guard 140 may be a substantially solid sheet configured to reflect and direct heat emitted by the first heating element 114 toward the basket 120 to improve efficiency of the first heating element 114.

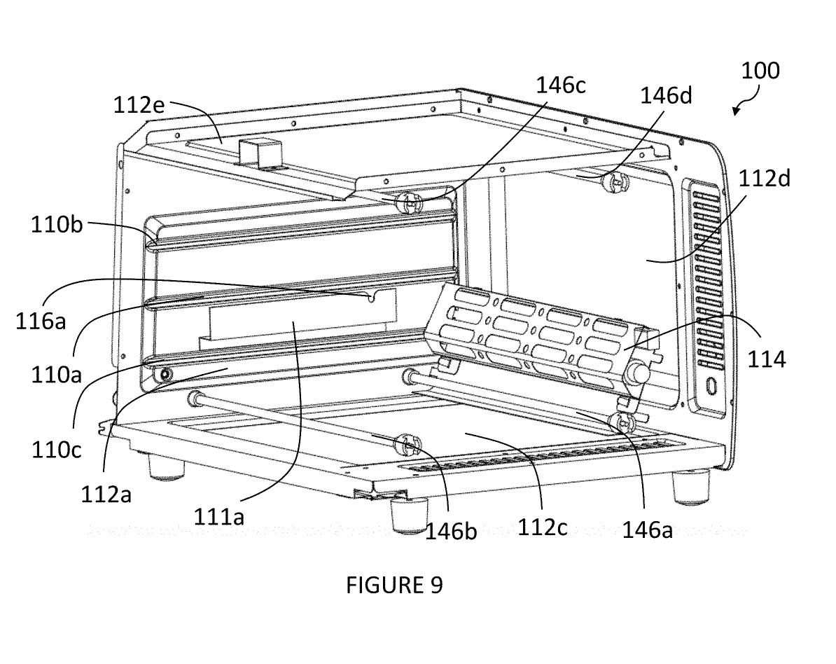

Referring now to FIG. 9, there is shown an illustrative embodiment of the combination toaster oven and air fryer 100 including the first heating element 114 and a second heating element 146a, 146b, 146c, and 146d. The first heating element 114 is mounted within the cooking chamber defined by the door 104, the left-sidewall 112a, the right-sidewall 112b, a bottom wall 112c, a rear wall 112d, and the top wall 112e, adjacent to the rear wall 112e and the bottom wall 112c. The second heating elements 146a, 146b, 146c, and 146d are mounted throughout the cooking chamber. In the illustrative embodiment, the second heating elements 146a and 146b are each mounted on the left-sidewall 112a and the right-sidewall 112b, such that the second heating elements 146a and 146b extend across the bottom of the cooking chamber parallel to the bottom wall 112c. The second heating elements 146a and 146b are mounted below the left channel 110c and the right channel 110f, and above the bottom wall 112c, such that the second heating elements 146a and 146b do not contact a tray (not shown) installed on the channels 110c and 110f or the bottom wall 112c. Further, the second heating elements 146c and 146d are each mounted on the left-sidewall 112a and the right-sidewall 112b, such that the second heating elements 146c and 146d extend across the top of the cooking chamber parallel to the top wall 112e. The second heating elements 146c and 146d are mounted above the left channel 110c and the right channel 110f, and below the top wall 112e, such that the second heating elements 146c and 146d do not contact a tray (not shown) installed on the channels 110b and 110d or the top wall 112e. In various embodiments, the second heating element 146 may include additional resistive heaters mounted on anyone of the interior walls forming the cooking chamber. In other embodiments, the second heating element 146 may include fewer resistive heaters mounted in the cooking chamber, such as three resistive heaters, two resistive heaters, or a single resistive heater.

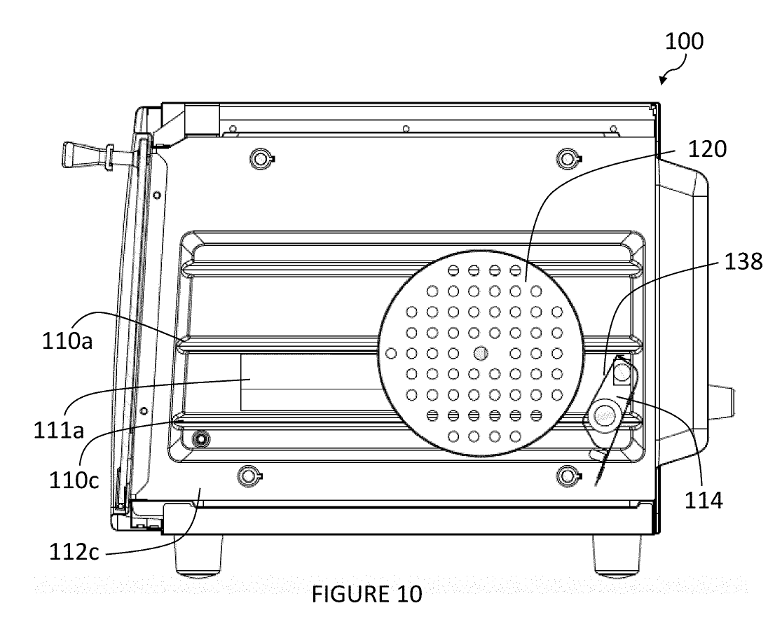

Referring now to FIG. 10, there is shown the illustrative embodiment, having the first heating element 114 mounted near the basket 120 to facilitate adequate and efficient cooking of a food product placed within the basket 120. The first heating element 114 may be mounted adjacent to the bottom wall 112c and the rear wall 112d of the housing such that the front guard 138 is 0.5 centimeters to 10 centimeters from the nearest surface of the basket 120. In operation, crumbs and other small food morsels or grease may fall from the basket 120 as the basket 120 rotates about the drive shaft 122. Thus, the portion of the cooking chamber approximately underneath the basket 120 is a crumb fall zone. While crumbs and other morsels may fall out of the rotating basket 120 and land on various portions of the bottom wall 112c, the portion of the bottom wall 112c directly beneath any portion of the basket 120 is termed “the crumb fall zone.”

In the illustrative embodiment, the first heating element 114 is positioned at one edge of the crumb fall zone, such that a portion of the first heating element 114 encroaches into the crumb fall zone. This positioning allows the first heating element to provide sufficient heat to cook food products within the basket 120, while removing the first heating element 114 from a vast majority of crumbs and food morsels falling from the basket 120. Additionally, any grease or other liquid seeping from the food product in the basket 120 will fall in the center of the crumb fall zone directly under the basket 120, and not on the first heating element 114. Further, the positioning of the front guard 138 deflects the few crumbs that fall at or outside the edge of the crumb fall zone and thereby shields the first heating element 114 from the crumbs and food morsels.

In various embodiments, the first heating element 114 may be positioned entirely outside of the crumb fall zone. Therefore, the first heating element may or may not include the front guard 138. In other embodiments, the first heating element may be positioned entirely within the crumb fall zone.

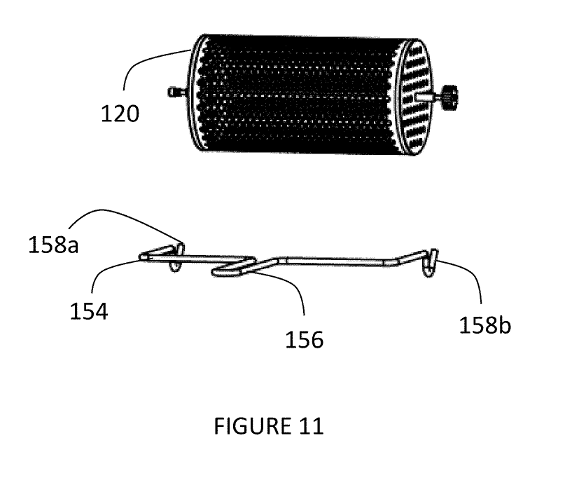

Referring now to FIG. 11, there is shown a basket removal tool 154 having a handle 156 and two drive shaft receivers 158a and 158b. In the illustrative embodiment, the basket removal tool 154 is a single piece of shaped metal bar having a diameter of 5 millimeters. In other embodiments, the diameter of the shaped metal bar may range from 2 millimeters up to 2 centimeters. In the illustrative embodiment, the basket removal tool 154 may be formed from a single piece, which is molded or bent into the desired final form. In various embodiments, the basket removal tool 154 may be formed from multiple pieces fused together or affixed to one another. The basket removal tool 154 may be formed from any of a variety of core materials instead of only shaped metal bar, and the core material may have a circular cross-section, a rectangular cross-section, or any other suitable cross-section shape. Thus, the basket removal tool 154 may be formed from a heat resistant composite, steel, stainless steel, enameled steel, aluminum, or other heat resistant material having sufficient strength to support the weight of the basket 120 and food product therein. In various embodiments, the handle 156 may be crafted from plastic, leather, or some other moldable or shapeable material affixed to the core material comprising the basket removal tool 154. The handle 156 may further be ergonomically shaped to form a readily graspable surface.

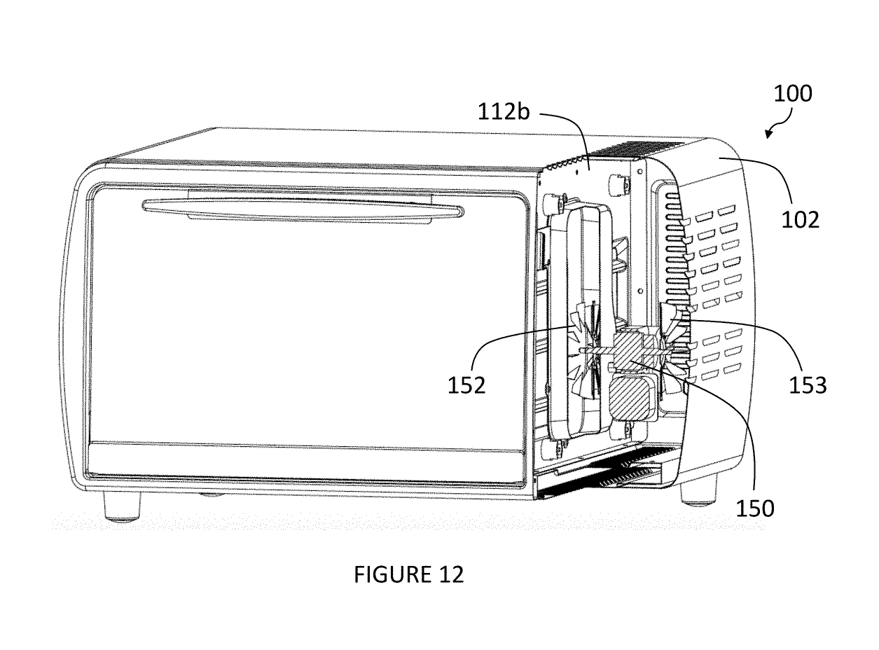

Referring now to FIG. 12, there is shown the illustrative embodiment of the combination toaster oven and air fryer 100 including a fan chamber, which houses a fan motor 150 and a fan 152 mounted upon the fan motor 150. The fan chamber is defined by the housing 102 and the right-side wall 112b. In various embodiments, the right-sidewall 112b may further comprise one or more vents (not shown) allowing the fan to move air within the cooking chamber. In a still further embodiment, the housing 102 may further comprise a second plurality of vents disposed in the housing 102 about the fan chamber such that air within the fan chamber is exchanged with air outside the combination toaster oven and air fryer 100 through operation of the fan 152. In one embodiment, the vents are channels mounted on the sidewall 112b. The channels include an upper and a lower channel. The fan 152 may draw cooler air out of the cooking chamber through the lower channel and return warmer air through the upper channel into the cooking chamber. In various embodiments, the fan chamber may further house a second fan 153 mounted on the fan motor 150. The second fan 153 is mounted on the fan motor 150 such that the second fan 153 directs air in the opposite direct of the first fan 152. In various embodiments, the second fan 153 may counter-balance the rotation of the first fan 152, thereby reducing noise produced by operation of the first fan 152. The second fan 153 may also cool the fan motor 150 by exhausting hot air from the fan chamber outside the housing 102, through vents (not shown) in the housing 102.

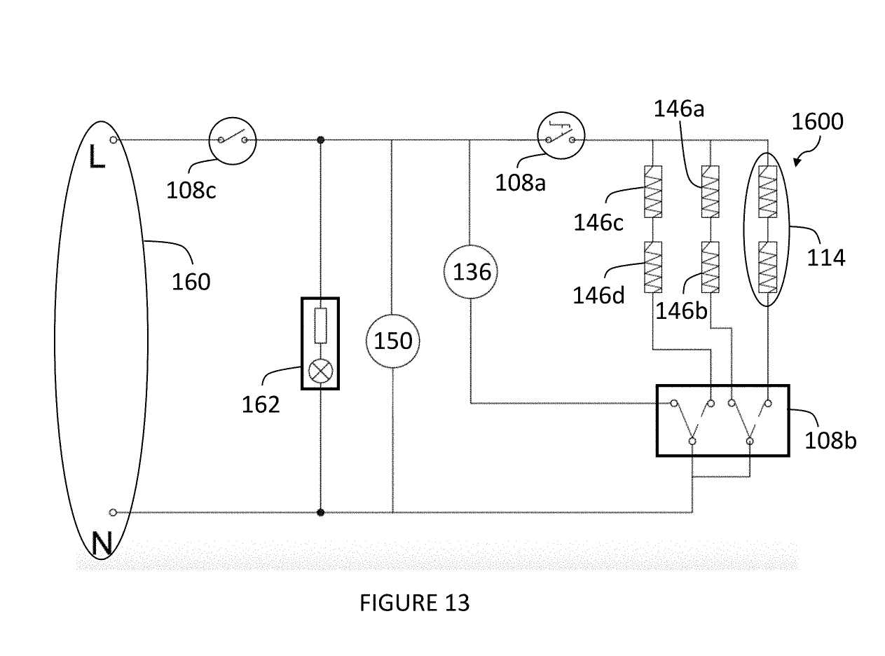

Referring now to FIG. 13, there is shown an electrical circuit diagram 1600 of the illustrative combination toaster oven and air fryer 100. The combination toaster oven and air fryer 100 may include a power supply 160, the timer 108c, an indicator light 162, the fan motor 150, the drive element 136, the temperature selector 108a, the second heating elements 146a, 146b, 146c, and 146d, and the first heating element 114. The power supply may provide power through the timer 108c to the indicator light 162, the fan motor 150, the drive element 136, the temperature selector 108a, and the cooking function selector 108b. The temperature selector 108a and cooking function selector 108b function to selectively allow power from the power supply 160 to flow through one or more of the first heating element 114 and the second heating elements 146a, 146b, 146c, and 146d.

In an illustrative example of operation, a user may select a non-zero time on the timer 108c, i.e. 20 minutes, select Broil on the cooking function selector 108b, and a temperature on the temperature selector 108a, i.e. 350 degrees Fahrenheit, to begin a cooking session. While the timer 108c indicates a non-zero time, the timer 108a allows power to flow through the indicator light 162, the fan motor 150, and the cooking function selector 108b. Thus, during operation the indicator light illuminates to indicate that the combination toaster oven and air fryer 100 is pre-heating or cooking; and the fan motor 150 spins the fan 152 to circulate air through the cooking chamber. The Broil mode of the cooking function selector 108b allows power to flow only through the fan motor 150 and the second heating elements 146c and 146d, thereby providing heat only from the top of the cooking chamber, above a food product and the basket 120. The fan motor 150 operates to circulate air through the cooking chamber at all times that the timer 108c indicates a non-zero time. The temperature selector 108a allows power to flow through the second heating elements 146c and 146d until the temperature inside the cooking chamber, determined by the thermostat (not shown), reaches the selected temperature, 350 degrees Fahrenheit. Upon reaching 350 degrees within the cooking chamber, the temperature selector 108a opens the circuits and prevents power from flowing to the second heating elements 146c and 146d. When the temperature inside the cooking chamber, as determined by the thermostat, drops below 350 degrees the temperature selector 108a closes the circuit and allows power to resume flowing through the second heating elements 146c and 146d to maintain the selected temperature within the cooking chamber. In various embodiments, the temperature selector 108a may operate to maintain a temperature range centered about the selected temperature, such as plus or minus 5 degrees Fahrenheit, i.e. 350+/− degrees Fahrenheit. In other embodiments, the temperature range maintained may be plus or minus 1 degree Fahrenheit, plus or minus 10 degrees Fahrenheit, or plus or minus 20 degrees Fahrenheit. The temperature selector 108a operates such that upon reaching a temperature in the cooking chamber that is within the prescribed range of temperatures maintained about the selected temperature, i.e. a temperature within the range 345-355 degrees Fahrenheit, the temperature selector 108a shuts off the second heating elements 146c and 146d; and when the temperature in the cooking chamber drops below the bottom end of the prescribed range of temperatures maintained about the selected temperature, i.e. below 345 degrees Fahrenheit, the temperature selector 108a engages the second heating elements 146c and 146d until the temperature within the cooking chamber reaches a temperature within the prescribed range of temperatures maintained about the selected temperature, i.e. a temperature within the range 345-355 degrees Fahrenheit. Additionally, the temperature selector 108a operates to shut off power to the second heating elements 146c and 146d when the temperature within the cooking chamber exceeds the top end of the prescribed range of temperatures maintained about the selected temperature, i.e. a temperature above 355 degrees Fahrenheit.

Alternatively, a user may select 20 minutes on the timer 108c, select Rotisserie on the cooking function selector 108b, and 350 degrees Fahrenheit on the temperature selector 108a to begin a cooking session. While the timer 108a indicates a non-zero time, the timer 108a allows power to flow through the indicator light 162, the fan motor 150, and the cooking function selector 108b. Thus, during operation the indicator light illuminates to indicate that the combination toaster oven and air fryer 100 is pre-heating or cooking; and the fan motor 150 spins the fan 152 to circulate air through the cooking chamber. The fan motor 150 operates to circulate air through the cooking chamber at all times that the timer 108c indicates a non-zero time. The Rotisserie mode of the cooking function selector 108b allows power to flow through the drive element 136, which causes the basket 120 to rotate during the cooking session; and allows power through only the second heating elements 146c and 146d, thereby providing heat from the top of the cooking chamber, above a food product and the basket 120. The temperature selector 108a allows power to flow through the second heating elements 146c and 146d until the temperature inside the cooking chamber reaches a temperature within the range 345-355 degrees Fahrenheit. Upon reaching a temperature within the range 345-355 degrees Fahrenheit inside the cooking chamber, the temperature selector 108a opens the circuits and prevents power from flowing to the second heating elements 146c and 146d. When the temperature inside the cooking chamber, as determined by the thermostat, drops below the 345 degrees Fahrenheit the temperature selector 108a closes the circuit and allows power to resume flowing through the second heating elements 146c and 146d to maintain the temperature within the cooking chamber within the range 345-355 degrees Fahrenheit. The temperature selector 108a operates such that upon reaching a temperature within the range 345-355 degrees Fahrenheit inside the cooking chamber the temperature selector 108a shuts off the second heating elements 146c and 146d; and when the temperature in the cooking chamber drops below 345 degrees Fahrenheit the temperature selector 108a engages the second heating elements 146c and 146d until the temperature within the cooking chamber reaches a temperature within the range 345-355 degrees Fahrenheit. Additionally, the temperature selector 108a operates to shut off power to the second heating elements 146c and 146d when the temperature within the cooking chamber exceeds 355 degrees Fahrenheit.

Alternatively, a user may select 5 minutes on the timer 108c, select Toast on the cooking function selector 108b, and 400 degrees Fahrenheit on the temperature selector 108a to begin a cooking session. While the timer 108a indicates a non-zero time, the timer 108a allows power to flow through the indicator light 162, the fan motor 150, and the cooking function selector 108b. Thus, during operation the indicator light illuminates to indicate that the combination toaster oven and air fryer 100 is pre-heating or cooking; and the fan motor 150 spins the fan 152 to circulate air through the cooking chamber. The fan motor 150 operates to circulate air through the cooking chamber at all times that the timer 108c indicates a non-zero time. The Toast mode of the cooking function selector 108b allows power to flow only through the second heating elements 146a, 146b, 146c, and 146d, thereby providing heat from the top and from the bottom of the cooking chamber, above and below a food product on a tray or rack (not shown). The temperature selector 108a allows power to flow through the second heating elements 146a, 146b, 146c, and 146d until the temperature inside the cooking chamber reaches a temperature within the range 395-405 degrees Fahrenheit. Upon reaching a temperature within the range 395-405 degrees Fahrenheit inside the cooking chamber, the temperature selector 108a opens the circuits and prevents power from flowing to the second heating elements 146a, 146b, 146c, and 146d. When the temperature inside the cooking chamber, as determined by the thermostat, drops below the 395 degrees Fahrenheit the temperature selector 108a closes the circuit and allows power to resume flowing through the second heating elements 146a, 146b, 146c, and 146d to maintain the temperature within the cooking chamber within the range 395-405 degrees Fahrenheit. The temperature selector 108a operates such that upon reaching a temperature within the range 395-405 degrees Fahrenheit inside the cooking chamber the temperature selector 108a shuts off the second heating elements 146a, 146b, 146c, and 146d; and when the temperature in the cooking chamber drops below 345 degrees Fahrenheit the temperature selector 108a engages the second heating elements 146a, 146b, 146c, and 146d until the temperature within the cooking chamber reaches a temperature within the range 395-405 degrees Fahrenheit. Additionally, the temperature selector 108a operates to shut off power to the second heating elements 146a, 146b, 146c, and 146d when the temperature within the cooking chamber exceeds 355 degrees Fahrenheit.

Alternatively, a user may select 45 minutes on the timer 108c, select Bake on the cooking function selector 108b, and 425 degrees Fahrenheit on the temperature selector 108a to begin a cooking session. While the timer 108a indicates a non-zero time, the timer 108a allows power to flow through the indicator light 162, the fan motor 150, and the cooking function selector 108b. Thus, during operation the indicator light illuminates to indicate that the combination toaster oven and air fryer 100 is pre-heating or cooking; and the fan motor 150 spins the fan 152 to circulate air through the cooking chamber. The fan motor 150 operates to circulate air through the cooking chamber at all times that the timer 108c indicates a non-zero time. The Bake mode of the cooking function selector 108b allows power to flow only through the second heating elements 146a and 146b, thereby providing heat from the bottom of the cooking chamber, below a food product on a tray (not shown). The temperature selector 108a allows power to flow through the second heating elements 146a and 146b until the temperature inside the cooking chamber reaches a temperature within the range 420-430 degrees Fahrenheit. Upon reaching a temperature within the range 420-430 degrees Fahrenheit inside the cooking chamber, the temperature selector 108a opens the circuits and prevents power from flowing to the second heating elements 146a and 146b. When the temperature inside the cooking chamber, as determined by the thermostat, drops below the 420 degrees Fahrenheit the temperature selector 108a closes the circuit and allows power to resume flowing through the second heating elements 146a and 146b to maintain the temperature within the cooking chamber within the range 420-430 degrees Fahrenheit. The temperature selector 108a operates such that upon reaching a temperature within the range 395-405 degrees Fahrenheit inside the cooking chamber the temperature selector 108a shuts off the second heating elements 146a and 146b; and when the temperature in the cooking chamber drops below 420 degrees Fahrenheit the temperature selector 108a engages the second heating elements 146a and 146b until the temperature within the cooking chamber reaches a temperature within the range 420-430 degrees Fahrenheit. Additionally, the temperature selector 108a operates to shut off power to the second heating elements 146a and 146b when the temperature within the cooking chamber exceeds 430 degrees Fahrenheit.

Alternatively, a user may select 15 minutes on the timer 108c, select Air Fryer on the cooking function selector 108b, and 350 degrees Fahrenheit on the temperature selector 108a to begin a cooking session. While the timer 108a indicates a non-zero time, the timer 108a allows power to flow through the indicator light 162, the fan motor 150, and the cooking function selector 108b. Thus, during operation the indicator light illuminates to indicate that the combination toaster oven and air fryer 100 is pre-heating or cooking; and the fan motor 150 spins the fan 152 to circulate air through the cooking chamber. The fan motor 150 operates to circulate air through the cooking chamber at all times that the timer 108c indicates a non-zero time. The Air Fryer mode of the cooking function selector 108b allows power to flow through the drive element 136, which causes the basket 120 to rotate during the cooking session; and allows power through only the first heating element 114, thereby providing heat from behind and below a food product and the basket 120. The temperature selector 108a allows power to flow through the first heating element 114 until the temperature inside the cooking chamber reaches a temperature within the range 345-355 degrees Fahrenheit. Upon reaching a temperature within the range 345-355 degrees Fahrenheit inside the cooking chamber, the temperature selector 108a opens the circuits and prevents power from flowing to the first heating element 114. When the temperature inside the cooking chamber, as determined by the thermostat, drops below the 345 degrees Fahrenheit the temperature selector 108a closes the circuit and allows power to resume flowing through the sec first heating element 114 to maintain the temperature within the cooking chamber within the range 345-355 degrees Fahrenheit. The temperature selector 108a operates such that upon reaching a temperature within the range 345-355 degrees Fahrenheit inside the cooking chamber the temperature selector 108a shuts off the first heating element 114; and when the temperature in the cooking chamber drops below 345 degrees Fahrenheit the temperature selector 108a engages the first heating element 114 until the temperature within the cooking chamber reaches a temperature within the range 345-355 degrees Fahrenheit. Additionally, the temperature selector 108a operates to shut off power to the first heating element 114 when the temperature within the cooking chamber exceeds 355 degrees Fahrenheit.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses may differ from those just described, or be expanded on or implemented using technologies not yet commercially viable, and yet still be within the inventive concepts of the present disclosure. The scope of the invention is determined by the following claims and their legal equivalents.

What is claimed is:

1. A combination toaster oven and air fryer comprising:
a housing;
a door, the door coupled to the housing;
a fan, the fan within the housing;
a basket drive element;
a basket including a drive shaft, the basket having a first state and a second state, in the first state the basket is coupled to the basket drive element, in the second state the basket is separate from the basket drive element;
a first heating element including an infrared heater and a quartz heater;
a second heating element, the second heating element within the housing; and
a control panel.

2. The combination toaster oven and air fryer of claim 1 wherein the housing further comprises:
a right-sidewall interior surface having a horizontal right-sidewall rail disposed thereon, the right-sidewall rail having a right notch;
a left-sidewall interior surface including a horizontal left-sidewall rail disposed thereon, the left-sidewall rail having a left notch;
a rear sidewall interior surface;
a top wall interior surface; and
a bottom wall interior surface;
wherein the right-sidewall interior surface, the left-sidewall interior surface, the rear sidewall interior surface, the top wall interior surface, the bottom wall interior surface, and the door defining a cooking chamber; and
wherein the first heating element is located adjacent to the rear sidewall interior surface and the bottom wall interior surface.

3. The combination toaster oven and air fryer of claim 1 wherein the fan circulates heated air within the cooking chamber.

4. The combination toaster oven and air fryer of claim 1 further comprising a basket removal tool configured to couple to the basket.

5. The combination toaster oven and air fryer of claim 2 further comprising:
at least one channel mounted on the left-sidewall;
at least one channel mounted on the right-sidewall; and
a tray configured to interface with the left-sidewall channel and the right-sidewall channel.

7. The combination toaster oven and air fryer of claim 1 wherein the control panel further includes:
an air fryer cooking selection; and
a toaster cooking selection.

8. The combination toaster oven and air fryer of claim 1 wherein the first heating element further includes a crumb shield disposed between the basket and the tubular heaters.

9. The combination toaster oven and air fryer of claim 8 wherein the first heating element is located outside a crumb fall zone.

10. The combination toaster oven and air fryer of claim 1 wherein the control panel further includes:
a temperature selector having a plurality of temperature selections;
a function selector including the air fryer cooking selection and the toaster cooking selection; and
a timer selector.

11. The combination toaster oven and air fryer of claim 1 wherein the basket includes an exterior surface having a plurality of holes, each of the plurality of holes having a center, each of the plurality of holes further having a 6 millimeter hole diameter centered about the hole center, and the center of each of the plurality of holes separated from the center of any adjacent hole by 8.5 millimeters.

12. A combination toaster oven and air fryer comprising:
a housing;
a door, the door coupled to the housing;
a fan, the fan within the housing;
a basket drive element;
a basket including a drive shaft, the basket having a first state and a second state, in the first state the basket is coupled to the basket drive element, in the second state the basket is separate from the basket drive element;
a first heating element including an infrared heater and a quartz heater;
a second heating element, the second heating element within the housing; and
a control panel including an air fryer cooking selection and a toaster cooking selection.

13. The combination toaster oven and air fryer of claim 12 wherein the housing comprises:
a right-sidewall interior surface having at least one horizontal right-sidewall rail disposed thereon and at least one of the at least one right-sidewall rail having a right notch;
a left-sidewall interior surface having at least one horizontal left-sidewall rail disposed thereon and at least one of the at least one left-sidewall rail having a left notch;
a rear sidewall interior surface;
a top wall interior surface; and
a bottom wall interior surface;
the right-sidewall interior surface, the left-sidewall interior surface, the rear sidewall interior surface, the top wall interior surface, the bottom wall interior surface, and the door defining the cooking chamber; and
wherein the first heating element is located adjacent to the rear sidewall interior surface and the bottom wall interior surface.

14. The combination toaster oven and air fryer of claim 12 wherein the fan circulates heated air within the cooking chamber.

15. The combination toaster oven and air fryer of claim 12 further comprising a basket removal tool configured to couple to the basket.

16. The combination toaster oven and air fryer of claim 13 further comprising:
at least one channel mounted on the left-sidewall;
at least one channel mounted on the right-sidewall; and
a tray configured to interface with the left-sidewall channel and the right-sidewall channel.

17. The combination toaster oven and air fryer of claim 12 wherein the control panel further includes:
a temperature selector having a plurality of temperature selections;
a function selector including the air fryer cooking selection and the toaster cooking selection; and
a timer selector.

18. The combination toaster oven and air fryer of claim 12 wherein the first heating element further includes a crumb shield disposed between the basket and the tubular heaters.

19. The combination toaster oven and air fryer of claim 18 wherein the first heating element is located outside a crumb fall zone.

20. The combination toaster oven and air fryer of claim 12 wherein the basket includes an exterior surface having a plurality of holes, each of the plurality of holes having a center, each of the plurality of holes further having a 6 millimeter hole diameter centered about the hole center, and the center of each of the plurality of holes separated from the center of any adjacent hole by 8.5 millimeters.
